(19) United States
(12) Patent Application Publication
(10) Pub. No.: US 2025/0022336 A1
(43) Pub. Date: Jan. 16, 2025

(54) TERMINAL, METHOD AND COMPUTER PROGRAM

(71) Applicant: 17LIVE Japan Inc., Tokyo (JP)

(72) Inventors: Yi-Jou LEE, Taipei City (TW); Chen-Hsih WU, Taipei City (TW)

(21) Appl. No.: 18/435,676

(22) Filed: Feb. 7, 2024

(30) Foreign Application Priority Data
Jul. 14, 2023 (JP) 2023-115665

(51) Int. Cl. G07F 11/70; H04N 21/2187

(52) U.S. Cl. CPC G07F 11/70; H04N 21/2187

(57) ABSTRACT

A method for operating functions of a vending machine, comprising: generating a first streaming data of a first user; transmitting the first streaming data to a server; receiving a second streaming data from the server; reproducing the second streaming data on a screen of the terminal; receiving information of a product selected by the first user; providing the selected product to the first user. According to the present disclosure, the product may be customized according to the user's preference and the user may also interact with the livestreamer in a more variety of ways. Therefore, the user experience may be improved.

### CROSS-REFERENCE TO RELATED APPLICATIONS

This application is based on and claims the benefit of priority from Japanese Patent Application Serial No. 2023-115665 (filed on Jul. 14, 2023), the contents of which are hereby incorporated by reference in its entirety.

### TECHNICAL FIELD

This disclosure relates to information and communication technology, and in particular, to a terminal, method and computer program in a live streaming.

### BACKGROUND

Nowadays, there are more and more vending machines on the street. The vending machines offer a wide variety of products, such as beverages, toys, and more. The vending machines may also operate 24 hours a day, 7 days a week, allowing customers to make purchases at any time.

In addition, many businesses also offer vending machines with products which are collaborated with popular characters, and it may motivate a larger number of consumers to spend money on them. The Non-Patent Document 1 discloses one kind of vending machine, which allows the user to purchase a blind box and open it with surprise.

However, the function of these vending machines is limited. With the advancement of technology, users have increasingly high expectations for the services provided by machines. Therefore, it is crucial to explore ways to further improve these machines.
[Non-Patent Document 1]: https://www.youtube.com/watch?v=OLPzaIw9TIE

### SUMMARY

An embodiment of subject application relates to a terminal for operating functions of a vending machine, comprising one or a plurality of processors, wherein the one or plurality of processors execute a machine-readable instruction to perform: generating a first streaming data of a first user; transmitting the first streaming data to a server; receiving a second streaming data from the server; reproducing the second streaming data on a screen of the terminal: receiving information of a product selected by the first user; providing the selected product to the first user.

Another embodiment of subject application relates to a method for operating functions of a vending machine, comprising: generating a first streaming data of a first user; transmitting the first streaming data to a server; receiving a second streaming data from the server; reproducing the second streaming data on a screen of the terminal; receiving information of a product selected by the first user; providing the selected product to the first user.

Another embodiment of subject application relates to a computer program for causing a terminal to realize the functions of: generating a first streaming data of a first user; transmitting the first streaming data to a server; receiving a second streaming data from the server; reproducing the second streaming data on a screen of the terminal; receiving information of a product selected by the first user; providing the selected product to the first user.

According to the present disclosure, the product may be customized according to the user's preference and the user may also interact with the livestreamer in a more variety of ways. The user may further be a livestreamer to interact with the other livestreamer and purchase products in a more variety of ways. Therefore, the user experience may be improved.

### BRIEF DESCRIPTION OF THE DRAWINGS

FIG. 1 is a schematic configuration of a live streaming system 1 according to some embodiments of subject application;

FIG. 2 is a schematic block diagram of the user terminal 20 according to some embodiments of subject application;

FIG. 3 is a schematic block diagram of the server 10 according to some embodiments of subject application;

FIG. 4 shows an exemplary data structure of the stream DB 320 of FIG. 3;

FIG. 5 shows an exemplary data structure of the user DB 322 of FIG. 3;

FIG. 6 shows an exemplary data structure of the purchase DB 324 of FIG. 3;

FIG. 7 shows an exemplary data structure of the product DB 270 of FIG. 2;

FIG. 8 shows an exemplary data structure of the material DB 272 of FIG. 2;

FIG. 9 shows an exemplary data structure of the customized product look-up table 274 of FIG. 2;

FIG. 10 shows an exemplary data structure of the context DB 276 of FIG. 2;

FIG. 11 shows an exemplary data structure of the game DB 278 of FIG. 2;

FIG. 12 is an illustrating example operation of the terminal 30c according to some embodiments of subject application;

FIG. 13-FIG. 19 are exemplary screen images of a live-streaming room screen 600 shown on the display of the livestreamer user terminal 20 or the viewer user terminal 30;

FIG. 20 is an illustrating example operation of the product P according to some embodiments of subject application;

FIG. 21 is an illustrating example operation of the terminal 30c according to some embodiments of subject application;

FIG. 22 is a flowchart showing steps of purchasing a product on a user terminal;

FIG. 23 is an exemplary hardware configuration of the information processing device according to some embodiments of subject application.

### DESCRIPTION OF THE EMBODIMENTS

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

The live streaming system 1 according to some embodiments of subject application provides enhancement among the users to communicate and interact smoothly. More specifically, it entertains the viewers and livestreamers in a technical way.

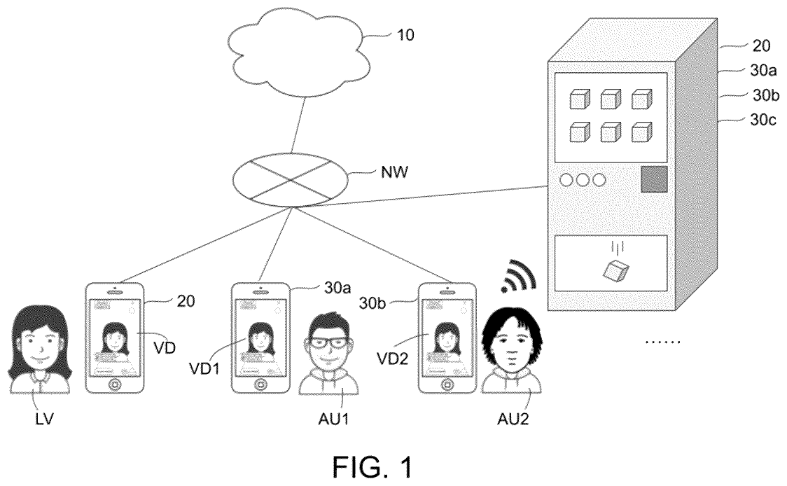

FIG. 1 shows a schematic configuration of a live streaming system 1 according to some embodiments of subject application. The live streaming system 1 provides a live streaming service for the streaming livestreamer (may also be referred as liver, streamer or distributor) LV and viewer (may also be referred as audience) AU (AU1, AU2 . . . ) to interact mutually in real time. As shown in FIG. 1, the live streaming system 1 may include a server 10, a user terminal 20 and a user terminal 30 (30a, 30b . . . ). The user terminal 20 may be a livestreamer and the user terminal 30 may be a viewer. In some embodiments, the livestreamers and viewers may be referred to as the user.

The server 10 may include one or a plurality of information processing devices connected via network NW. The user terminal 20 and 30 may be, for example, a portable terminal such as the smartphone, tablet, laptop PC, recorder, mobile game console, wearable device or the like, or the stationary computer such as desktop PC. The server 10, user terminal 20 and user terminal 30 may be communicably connected by any type of wire or wireless network NW.

The live streaming system 1 is involved in the livestreamer LV, the viewer AU, and APP provider (not shown), who provides the server 10. The livestreamer LV may record his/her own contents such as songs, talks, performance, game streaming or the like by his/her own user terminal 20 and upload to the server 10 and be the one who distributes contents in real time. In some embodiments, the livestreamer LV may interact with the viewer AU via the live streaming.

The APP provider may provide a platform for the contents to go on live streaming in the server 10. In some embodiments, the APP provider may be the media or manager to manage the real time communication between the livestreamer LV and viewer AU. The viewer AU may access the platform by the user terminal 30 to select and watch the contents he/she would like to watch. The viewer AU may perform operations to interact with the livestreamer, such as commenting or cheering the livestreamer, by the user terminal 30. The livestreamer, who provides the contents, may respond to the comment or cheer. The response of the livestreamer may be transmitted to the viewer AU by video and/or audio or the like. Therefore, a mutual communication among the livestreamer and viewer may be accomplished.

The “live streaming” in this specification may be referred to as the data transmission which enables the contents the livestreamer LV recorded by the user terminal 20 to be substantially reproduced and watched by the viewer AU via the user terminal 30, In some embodiments, the “live streaming” may also refer to the streaming which is accomplished by the above data transmission. The live streaming may be accomplished by the well-known live streaming technology such as HTTP Live Streaming, Common Media Application Format, Web Real-Time Communications, Real-Time Messaging Protocol, MPEG DASH or the like.

The live streaming may further include the embodiment that the viewer AU may reproduce or watch the contents with specific delay while the livestreamer is recording the contents. Regarding the magnitude of the delay, it should be at least small enough to enable the livestreamer LV and the viewer AU to communicate. However, live streaming is different from so-called on-demand streaming. More specifically, the on-demand streaming may be referred to as storing all data, which records the contents, in the server and then providing the data from the server to the user at random timing according to the user's request.

The “streaming data” in this specification may be referred to as the data includes image data or voice data. More specifically, the image data (may be referred to as video data) may be generated by the image pickup feature of the user terminal 20 and 30. The voice data (may be referred to as audio data) may be generated by the audio input feature of the user terminal 20 and 30. The streaming data may be reproduced by the user terminal 20 30, so that the contents relating to users may be available for watching.

In some embodiments, during the period from the streaming data being generated by the user terminal of the livestreamer to being reproduced by the user terminal of the viewer, the processing of changing format, size or specification of the data, such as compression, extension, encoding, decoding, transcoding or the like, is predictable. Before and after this kind of processing, the contents (such as video and audio) are substantially unchanged, so it is described in the current embodiments of the present disclosure that the streaming data before being processed is the same as that after being processed. In other words, if the streaming data is generated by the user terminal of the livestreamer and reproduced by the user terminal of the viewer via the server 10, the streaming data generated by the user terminal of the livestreamer, the streaming data passed through the server 10 and the streaming data received and reproduced by the by the user terminal of the viewer are all the same streaming data.

As shown in FIG. 1, the livestreamer LV is providing the live streaming. The user terminal 20 of the livestreamer generates the streaming data by recording his/her video and/or audio, and transmits to the server 10 via the network NW. At the same time, the user terminal 20 may display the video VD on the display of the user terminal 20 to check the streaming contents of the livestreamer LV.

The viewer AU1, AU2 of the user terminal 30a, 30b, 30c or the like, who request the platform to provide the live streaming of the livestreamer, may receive streaming data corresponding to the live streaming via the network NW and reproduce the received streaming data to display the video VD1, VD2 on the display and output the audio from a speaker or the like. The video VD1, VD2 displayed on the user terminal 30a, 30b respectively may be substantially the same as the video VD recorded by the user terminal of the livestreamer LV, and the audio outputted from the terminal 30a, 30b may also be substantially the same as the audio recorded by the user terminal of the livestreamer LV.

The recording at the user terminal 20 of the livestreamer may be simultaneous with the reproducing of the streaming data at the user terminal 30a, 30b of the viewer AU1, AU2. If a viewer AU1 inputs a comment on the contents of the livestreamer LV into the user terminal 30a, the server 10 will display the comment on the user terminal 20 of the livestreamer in real time, and also display on the user terminal 30a, 30b of the viewer AU1, AU2 respectively. If the livestreamer LV responds to the comment, the response may be outputted as the text, image, video or audio from the terminal 30a, 30b of the viewer AU1, AU2, so that the communication of the livestreamer LV and viewer LV may be realized. Therefore, the live streaming system may realize the live streaming of two-way communication.

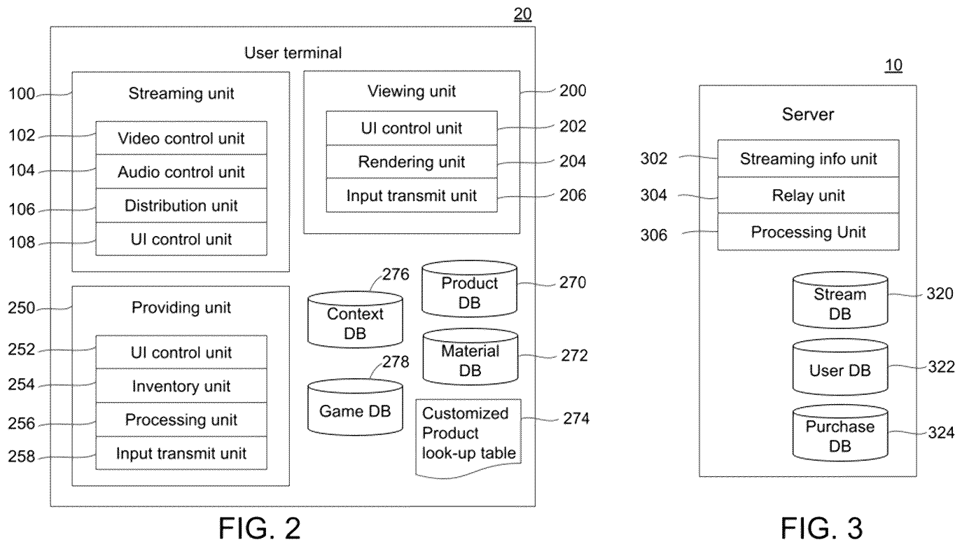

FIG. 2 is a block diagram showing a function and configuration of the user terminal 20 in FIG. 1 according to the embodiment of the present disclosure. The user terminal 30 has the similar function and configuration of the user terminal 20. The blocks depicted in the block diagram of this specification are implemented in hardware such as devices like a CPU of a computer or mechanical components, and in software such as a computer program depicts functional blocks implemented by the cooperation of these elements. Therefore, it will be understood by those skilled in the art that the functional blocks may be implemented in a variety of manners by a combination of hardware and software.

The livestreamer LV and viewer AU may download and install the live streaming application (live streaming APP) of the present disclosure to the user terminal 20 and 30 from the download site via network NW. Or the live streaming APP may be pre-installed in the user terminal 20 and 30. By the execution of the live streaming by the user terminal 20 and 30, the user terminals 20 and 30 may communicate with the server 10 via the network NW to realize a plurality of functions.

The functions realized by the execution of the live streaming APP by the user terminal 20 and 30 (More specifically, the processor such as CPU) is described below as the functions of the user terminal 20 and 30. These functions are basically the functions that the live streaming APP makes the user terminals 20 and 30 realize. In some embodiments, these functions may also be realized by transmitting from the server 10 to the web browser of the user terminal 20 and 30 via network NW and be executed by the computer program of the web browser. The computer program may be written in the programming language such as HTML (Hyper Text Markup Language) or the like.

The user terminal 20 includes streaming unit 100, viewing unit 200, processing unit 250, product DB 270, material DB 272, customized product look-up table 274, context DB 276 and game DB 278. In some embodiments, the streaming unit 100 is configured to record the audio and/or video data of the user and generate streaming data to transmit to the server 10. The viewing unit 200 is configured to receive and reproduce streaming data from server 10.

In some embodiments, a user may activate the streaming unit 100 when broadcasting or activate the viewing unit 200 when watching streaming respectively. In some embodiments, the user terminal who is activating the streaming unit 100 may be referred to as an livestreamer or be referred to as the user terminal which generates the streaming data. The user terminal who is activating the viewing unit 200 may be referred to as an viewer or be referred to as the user terminal which reproduces the streaming data.

The streaming unit 100 may include video control unit 102, audio control unit 104, distribution unit 106 and UI control unit 108. The video control unit 102 may be connected to a camera (not shown) and the video is controlled by the camera. The video control unit 102 may obtain the video data from the camera. The audio control unit 104 may be connected to a microphone (not shown) and the audio is controlled by the microphone. The audio control unit 104 may obtain the audio data from the microphone.

The distribution unit 106 receives streaming data, which includes video data from the video control unit 102 and audio data from the audio control unit 104, and transmits to the server 10 via network NW. In some embodiments, the distribution unit 106 transmits the streaming data in real-time. In other words, the generation of the streaming data from the video control unit 102 and audio control unit 104, and the distribution of the distribution unit 106 is performed simultaneously.

The UI control unit 108 controls the UI for the livestreamer. The UI control unit 108 is connected to a display (not shown) and is configured to generate the streaming data to whom the distribution unit 106 transmits, reproduces and displays the streaming data on the display. The UI control unit 108 shows the object for operating or the object for instruction-receiving on the display and is configured to receive the tap input from the livestreamer.

The viewing unit 200 may include UI control unit 202, rendering unit 204 and input transmit unit 206. The viewing unit 200 is configured to receive streaming data from server 10 via network NW. The UI control unit 202 controls the UI for the viewer. The UI control unit 202 is connected to a display (not shown) and/or speaker (not shown) and is configured to display the video on the display and output the audio from the speaker by reproducing the streaming data. In some embodiments, Outputting the video on the display and audio from the speaker may be referred to as “reproducing the streaming data”. The UI control unit 202 may be connected to an input unit such as touch panel, keyboard or display or the like to obtain input from the users.

The rendering unit 204 may be configured to render the streaming data from the server 10 and the frame image. The frame image may include user interface objects for receiving input from the user, the comments inputted by the viewers and the data received from the server 10. The input transmit unit 206 is configured to receive the user input from the UI control unit 202 and transmit to the server 10 via the network NW.

In some embodiments, the user input may be clicking an object on the screen of the user terminal such as selecting a live stream, entering a comment, sending a gift, following or unfollowing an user, voting in an event, gaming or the like. For example, the input transmit unit 206 may generate gift information and transmit to server 10 via the internet NW if the user terminal of the viewer clicks a gift object on the screen in order to send a gift to the livestreamer.

The providing unit 250 may include UI control unit 252, inventory unit 254, processing unit 256 and input transmit unit 258. The providing unit 250 is configured to provide the product to the user. The UI control unit 252 controls the UI for the viewer. The UI control unit 252 is configured to display the product selection on the display. In some embodiments, the UI control unit 252 may output the audio from the speaker once, for example, the user selects a product, finished purchase or the like. The UI control unit 252 may also be connected to an input unit such as touch panel, keyboard or display or the like to obtain input from the users.

The inventory unit 254 may be configured to confirm the inventory of the product or material from the product DB 270 or material DB 272. For example, once the user selects a product, the inventory unit 254 may refer to the product DB 270 to confirm whether there is any inventory of the product. If the user selects a customized product, the inventory unit 254 may refer to the customized product look-up table 274 to check the materials of the customized product and refer to the material DB 272 to confirm whether there is any inventory of the material or the like. In some embodiments, if the product or materials is running low or out of stock, a warning message or error message may be displayed to notify the user.

The processing unit 256 may be configured to process the providing of product or customized product for the user. For example, if the product is available, the processing unit 256 may provide the user with the product. If the material for the customized product is available, the processing unit 256 may refer to the customized product look-up table 274 to check the method, materials, condition or the like of the customized product and further manufacturing the customized product for the user. In some embodiments, if the condition does not satisfy the information of the user, a warning message or error message may be displayed to notify the user.

In some embodiments, the frame image may include user interface objects for receiving input from the user such as selection of the products or customized products. The input transmit unit 206 is configured to receive the user input from the UI control unit 252 and transmit to the corresponding unit or server 10 via the network NW.

In some embodiments, the user input may be clicking an object on the screen of the user terminal such as selecting the products or customized products. For example, the input transmit unit 258 may generate product information and transmit to server 10 via the internet NW if the user terminal of the user clicks a product on the screen 600 in order to purchase a product.

In some embodiments, a payment system (not shown) may also be introduced into the live streaming system 1. The payment system may be configured to deal with the financial transactions. In some embodiments, the payment system may be a separated system from the server 10 or terminal, or may be integrated into the server 10 or terminal or the like. In some embodiments, the products may be purchased by virtual items such as the points, or by cash, credit card or the like. In some embodiments, the design of the payment system may be determined flexibly according to the practical need.

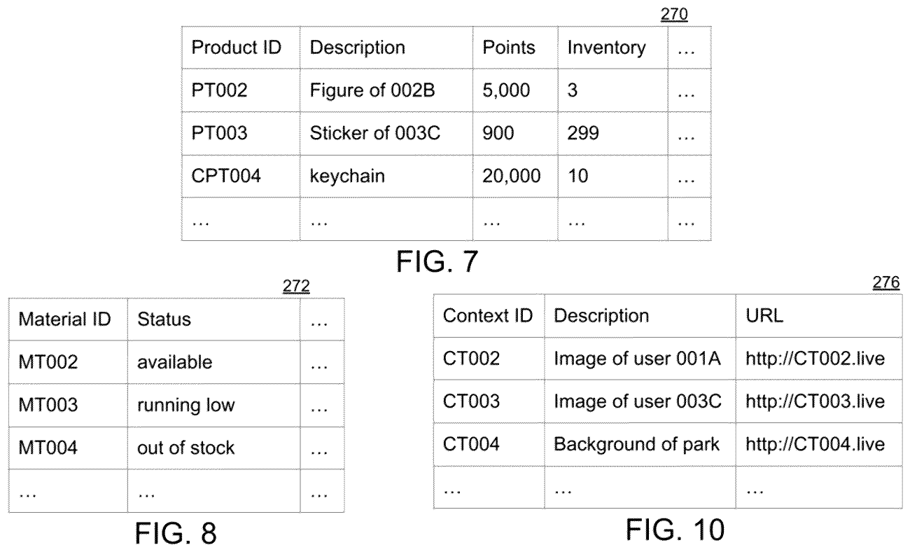

FIG. 7 shows an exemplary data structure of the product DB 270 of FIG. 2. The product DB 270 holds information regarding a product. The product may be a pre-manufactured product, customized products or the like. The product DB 270 stores a product ID for identifying a product on a live distribution platform provided by the live-streaming system 1, a description for identifying the description of the product, points for identifying the point of the product, inventory for identifying the inventory status of the product, in association with each other.

FIG. 8 shows an exemplary data structure of the material DB 272 of FIG. 2. The material DB 272 holds information regarding the material for manufacturing a product or customized product. The material DB 272 stores a material ID for identifying a material, a status for identifying the status of the material, in association with each other. In some embodiments, the material may be any possible material for manufacturing products such as metal, non-metal, paper, ink or the like.

In some embodiments, the materials may include plastic such as PLA or ABS, nylon, resin, metal, rubber or the like. The material may be with color or without color. In some embodiments, the material for coloring may include multicolor plastic, paints, dyes, pigment powders or the like. In some embodiments, the status of the material may be “available”, “running low”, “out of stock” or the like. In some embodiments, the materials and the setting of status may be determined flexibly according to practical need.

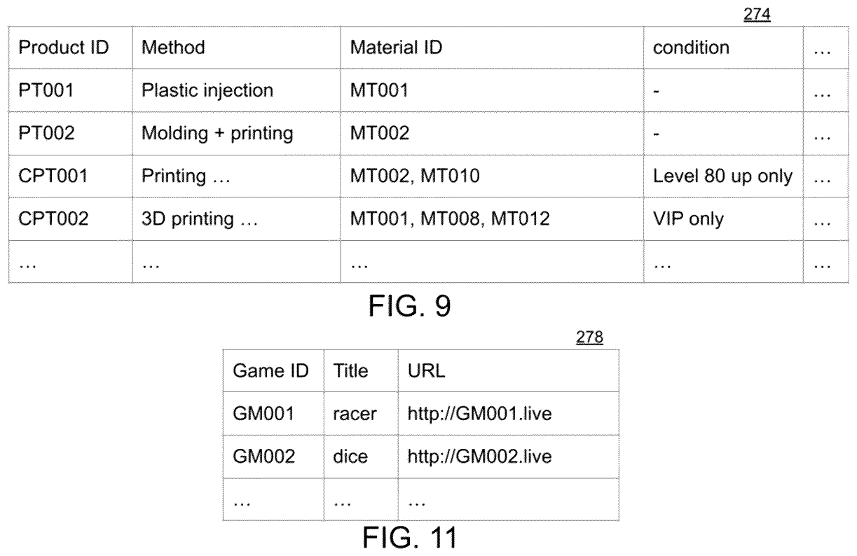

FIG. 9 shows an exemplary data structure of the customized product look-up table 274 of FIG. 2. The customized product look-up table 274 may be configured to store the information for manufacturing customized products or the like. In some embodiments, the customized product look-up table 274 may also include the information for manufacturing pre-manufactured products. Once the pre-manufactured product is out of stock and if the materials are available, the products may also be manufactured and provided to the user.

In some embodiments, the customized product look-up table 274 holds information regarding a product or customized product as described above. The customized product look-up table 274 stores a product ID for identifying a product or customized product on a live distribution platform provided by the live-streaming system 1, a method for identifying the method for manufacturing the products, material ID for identifying materials for manufacturing the products, conditions for identifying the specific condition for purchasing the products, in association with each other. For example, the method for manufacturing a keychain may be a 3D Printer with the materials of resin, metal, paints or the like. In some embodiments, the condition for purchasing the product may be determined flexibly according to the practical need.

FIG. 10 shows an exemplary data structure of the context DB 276 of FIG. 2. The context DB 276 holds information regarding a context. The context DB 276 stores a context ID for identifying a context, a description for identifying the description of the context, and a URL identifying the location of the context, in association with each other. In some embodiments, the context may be text object, image object, video object or the like provided by the live-streaming system 1 or uploaded by the user.

In some embodiments, the context may be the image or video of the livestreamers, and the image or video may be retrieved from live streaming data, archived data of the livestreamer or the like. In some embodiments, the context may also be some background image or video uploaded from the user, provided by the live-streaming system 1 or retrieved from the internet or the like. In some embodiments, the context may also be determined flexibly according to the practical need.

FIG. 11 shows an exemplary data structure of the game DB 278 of FIG. 2. The game DB 278 holds information regarding a game. The game DB 278 stores a game ID for identifying a game on a live distribution platform provided by the live-streaming system 1, a title for identifying the title of the game, and a URL for identifying the location of the game, in association with each other. In some embodiments, the game may be an on-line game or offline game. The game may be an interactive game with livestreamer or another user. The game may be pre-downloaded or played in real-time via the network. In some embodiments, the realization of playing games may be determined flexibly according to the practical need.

FIG. 3 is a schematic block diagram of the server 10 according to some embodiments of the subject application. The server 10 may include streaming info unit 302, relay unit 304, processing unit 306, stream DB 320, user DB 322 and purchase DB 324.

The streaming info unit 302 receives the request of live streaming from the user terminal 20 of the livestreamer via the network NW. Once receiving the request, the streaming info unit 302 registers the information of the live streaming on the stream DB 320. In some embodiments, the information of the live streaming may be the stream ID of the live streaming and/or the livestreamer ID of the livestreamer corresponding to the live streaming.

Once receiving the request of providing the information of the live streaming from the viewing unit 200 of the user terminal 30 via the network NW, the streaming info unit 302 refers to the stream DB 320 and generates a list of the available live streaming. The streaming info unit 302 then transmits the list to the user terminal 30 via the network NW. The UI control unit 202 of the user terminal 30 generates a live streaming selection screen according to the list and displays the list on the display of the user terminal 30.

Once the input transmit unit 206 of the user terminal 30 receives the selection of the live streaming from the viewer on the live streaming selection screen, it generates the streaming request including the stream ID of the selected live streaming and transmits to the server 10 via the network. The streaming info unit 302 may start to provide the live streaming, which is specified by the stream ID in the streaming request, to the user terminal 30. The streaming info unit 302 may update the stream DB 320 to add the viewer's viewer ID of the user terminal 30 to the livestreamer ID of the stream ID.

The relay unit 304 may relay the transmission of the live streaming from the user terminal 20 of the livestreamer to the user terminal 30 of the viewer in the live streaming started by the streaming info unit 302. The relay unit 304 may receive the signal, which indicates the user input from the viewer, from the input transmit unit 206 while the streaming data is reproducing. The signal indicating the user input may be the object-designated signal which indicates the designation of the object shown on the display of the user terminal 30. The object-designated signal may include the viewer ID of the viewer, the livestreamer ID of the livestreamer, who delivers the live streaming the viewer is viewing, and object ID specified by the object. If the object is a gift or the like, the object ID may be the gift ID or the like. Similarly, the relay unit 304 may receive the signal indicating the user input of the livestreamer, for example the object-designated signal, from the streaming unit 100 of the user terminal 20 while the streaming data is reproducing.

The processing unit 306 is configured to process requests in response to operations from a user terminal of a user. For example, the user may download game data or request context such as image of livestreamer or background materials from server 10. The processing unit 306 may refer to a corresponding database such as data DB (not shown), retrieve the game or context data, and further transmit them to the user terminal of the user.

In some embodiments, the processing unit 306 may also update the corresponding database in response to the operations from the user terminal of the user. For example, if the user purchases an item via the user terminal, the input transmit unit 258 may generate product information such as purchase record and transmit it to server 10. The processing unit 306 may refer to the purchases DB 324 and store the purchase record in the purchases DB 324 for reference or the like.

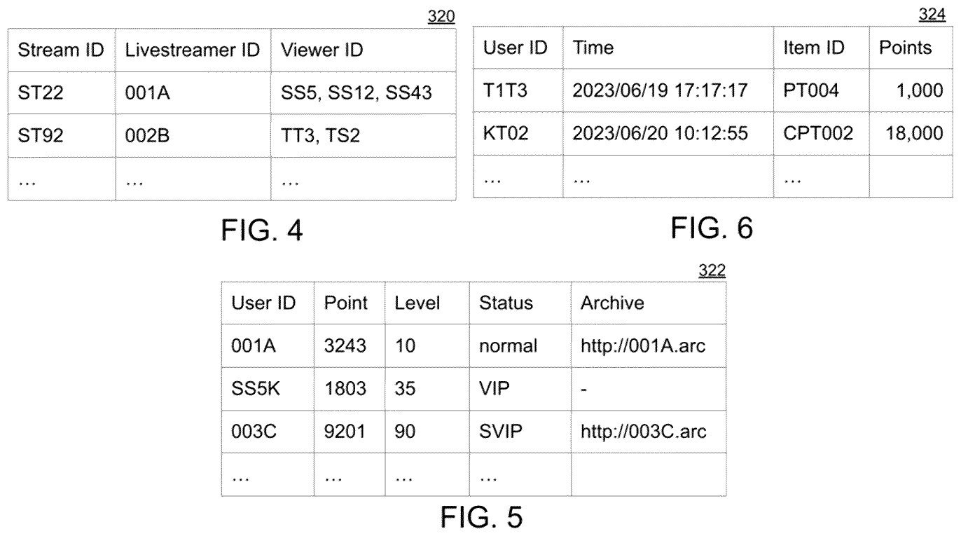

FIG. 4 shows an exemplary data structure of the stream DB 320 of FIG. 3. The stream DB 320 holds information regarding a live stream currently taking place. The stream DB 320 stores a stream ID for identifying a live-stream on a live distribution platform provided by the live-streaming system 1, a livestreamer ID for identifying the livestreamer who provides the live-stream, and a viewer ID for identifying a viewer of the live-stream, in association with each other.

FIG. 5 shows an exemplary data structure of the user DB 322 of FIG. 3. The user DB 322 holds information regarding users. The user DB 322 stores a user ID for identifying a user, points for identifying the points the user accumulates, level for identifying the level of the user and status for identifying the status of the user, in association with each other.

The point is the electronic value circulated within the live-streaming platform. The level may be an indicator of the amount of user activity or engagement on the live streaming platform. The status may be an identity or membership status of the user on the live streaming platform. In some embodiments, the products or customized products may be set with purchase conditions according to the information of the user. For example, some customized products may only be purchased by VIP users or users with level over 80.

In some embodiments, the user DB 322 may also store archives of the user. The archives may include the archive URL identifying the location of the archive contents. The archive contents may include images of the livestreamer or the like. According to the embodiments, images of the livestreamers may be retrieved even if the livestreamers are not online. In some embodiments, information related to the user may also be stored such as their display image, uploaded picture or the like.

FIG. 6 shows an exemplary data structure of the purchase DB 324 of FIG. 3. The purchase DB 324 holds information regarding the purchase records. The purchase DB 324 stores a user ID for identifying a user as a purchaser, time information for identifying time point of the purchase, item ID for identifying the products or customized products the user purchased, points for identifying the points the user spends on the product, in association with each other.

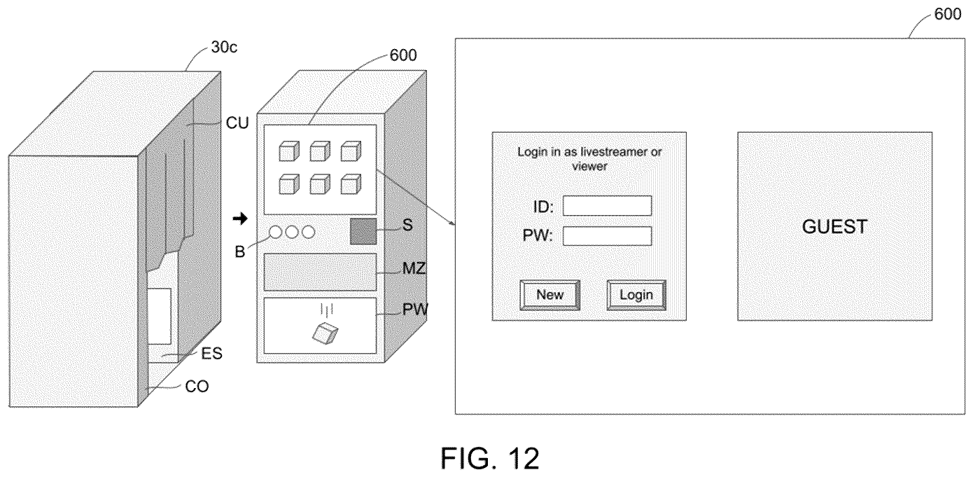

FIG. 12 is an illustrating example operation of the terminal 30c according to some embodiments of subject application. As shown in FIG. 12, the user terminal 30c may be a device or machine with a screen 600. In some embodiments, the terminal may be like a vending machine, photo booth, arcade cabinet, arcade machine or the like. The terminal may also include an enclosed space ES with cover CO or curtain CU for the user to perform operations privately.

In some embodiments, the screen 600 may be a touch screen for performing operations. The terminal may also include physical button B, sensor S, product manufacturing zone MZ, pickup window PW or the like. In some embodiments, specific equipment such as printers or 3D printers may be installed inside the manufacturing zone MZ. In some embodiments, the design and layout of the terminal may be determined flexibly according to the practical need.

The screen 600 may include an user interface for the user to perform operations. In some embodiments, the user may register or login in as an livestreamer or viewer, or perform operations as a guest. In some embodiments, some operations may not be allowed for the user as a guest. In some embodiments, the authority of being a livestreamer, viewer or guest may be set according to the practical need.

The screen 600 may include a plurality of tabs 602 for the user to switch among different features. In some embodiments, the screen 600 may include tabs 602 of “Product”, “Customize”, “LIVE”, “photo”, “game” or the like. The tab 602 of “Product” may include a list of pre-made products for the user to select, purchase or the like. The tab 602 of “Customize” may provide the user with the information of customized products. The tab 602 of “LIVE” may allow the user to watch live streaming or archived video, or allow the user to go on a live streaming. The tab 602 of “photo” may allow the user to take a photo, video or the like. The tab of “game” may allow the user to play games offline or online with other livestreamers or the like.

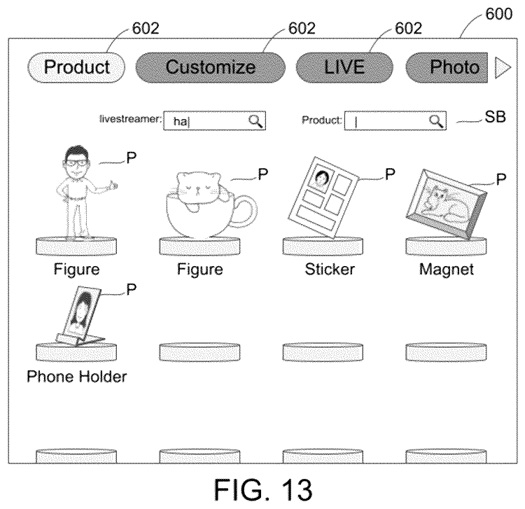

FIG. 13-FIG. 19 are exemplary screen images of a live-streaming room screen 600 shown on the display of the livestreamer user terminal 20 or the viewer user terminal 30. As shown in FIG. 13, a list of pre-made products P may be displayed on the screen 600. In some embodiments, the products P may be any kind of goods with characteristics of a livestreamer in the live-streaming platform or the like. For example, the product P may be a figure of a livestreamer, or a phone holder with an image of the virtual livestreamer or the like.

In some embodiments, the products P may also be some famous IP characters such as Barbie, Lego or the like. In some embodiments, a search bar SB may also be provided for the user to search for specific products or the products related to specific livestreamers. In some embodiments, the object of pre-made products P may also be displayed at a physical window separated from the screen 600 for the user to check the appearance of the products.

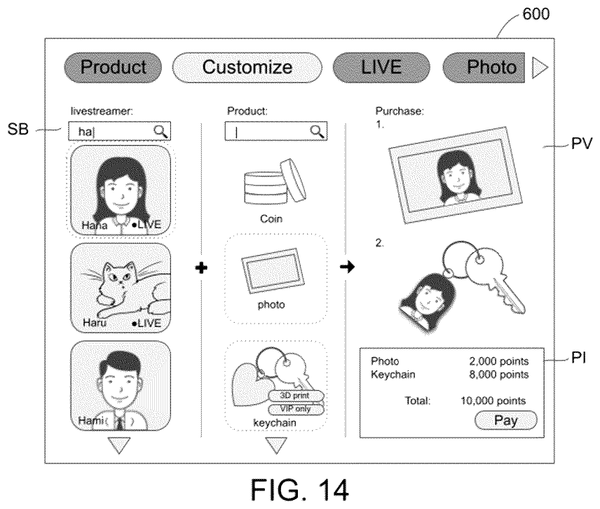

As shown in FIG. 14, the user may also purchase a customized product and the customized product may be manufactured according to their preference. For example, the user may select a livestreamer and a product to manufacture a customized product with the characteristics of the livestreamer. In some embodiments, a search bar SB may also be provided for the user to select the livestreamer, product or the like. In some embodiments, the providing unit 250 may refer to the material DB 272, customized product look-up table 274, context DB 276 or the like for manufacturing the customized product in response to the selection of the livestreamer and product from the user. For example, the user may select the livestreamer “Hana” and the product “photo”, and a photo of the livestreamer may be manufactured by printing or the like.

In some embodiments, a preview PV of the customized product may also be provided for the user to check the appearance of the finished product. In some embodiments, the user may also do some modifications on the finished product according to their preference. For example, the terminal may provide some default hair, face feature, body, clothing, gesture model with different shape or color for the user to customize their products.

In some embodiments, the user may also add decorations, move location of the livestreamer, rearrange each part of the product or the like to customize their products. In some embodiments, an exemplary customized product may also be displayed at a physical window separated from the screen 600 for the user to check the appearance of the customized products. In some embodiments, the design and layout of the customized product may be determined flexibly by the user according to the practical need.

The tab 602 of “Customize” may also include the purchase information PI for the user to proceed with the purchase procedure. In some embodiments, the purchase information PI may include the description of the customized products and its corresponding points, and also the total amount of the points. Once the user finishes the purchase procedure, the input transmit unit 258 may transmit the purchase record to server 10 and the processing unit 306 may store the purchase record in the purchases DB 324.

In some embodiments, the livestreamer who is selected in the pre-made product or customized product may receive a reward. The reward may be any possible virtual or substantial reward or the like. In some embodiments, the livestreamer may receive a reward if the livestreamer is on broadcasting when the product related to the livestreamer being purchased. For example, if the selected livestreamer is broadcasting, the livestreamer may receive the reward in the live streaming room.

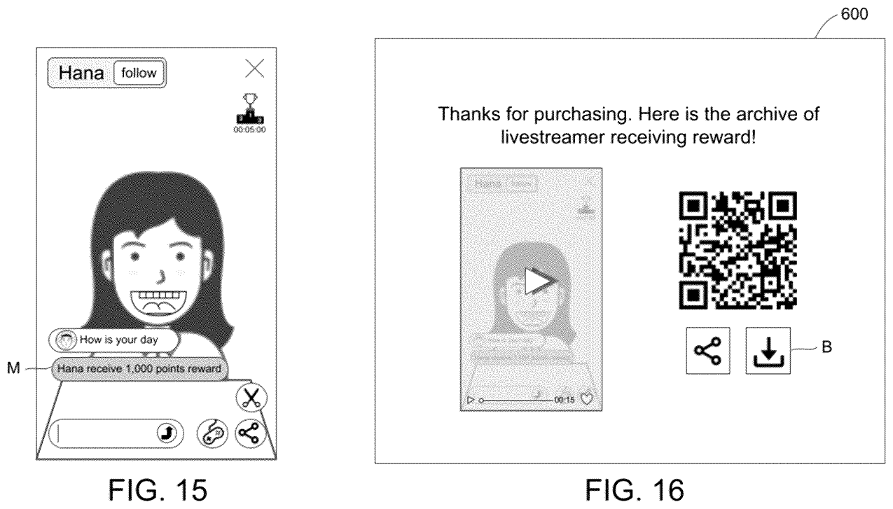

As shown in FIG. 15, a message M of “Hana receives 1,000 points reward” may be displayed in the live streaming room to inform the livestreamer of receiving the reward. In some embodiments, the portion of the livestreamer receiving reward may also be displayed on the terminal as shown in FIG. 16. According to the embodiments, the user may see the expression of the livestreamer receiving gifts and the livestreamer may thank the user in real-time.

In some embodiments, the portion of the livestreamer receiving reward may also be archived as an archive video. The link of the archive video may be provided on the products by a digital code or the like. For example, a QR code of the video may be printed on the bottom of the livestreamer's figure or the like. In some embodiments, the video may also be played on the screen 600 as shown in FIG. 16. The user may replay, fast forward, rewind the video or the like.

In some embodiments, a download button B may also be provided for the user to download the video as shown in FIG. 16. In some embodiments, the user may also share the video to another user or other social network platform. In some embodiments, the usage of the video may also be determined flexible according to the practical need. According to the embodiments, the interaction between the substantial terminal and virtual streaming room may be improved.

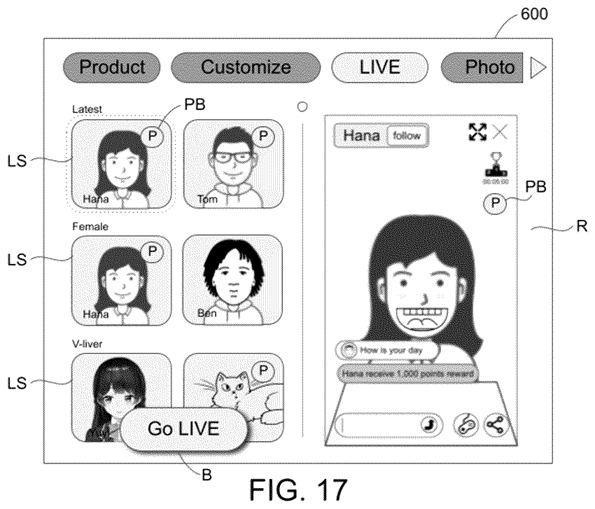

As shown in FIG. 17, the user may also watch live streaming or go broadcasting via the terminal. The tab 602 of “LIVE” may include a list of live streaming LS displayed on the screen 600 for the user to select and watch. In some embodiments, there may be a region R on the screen 600 to show the live streaming room or the like. The user may watch the live streaming while waiting for the manufacture of the customized products or the like. In some embodiments, the thumbnail of the live streaming or the live streaming room may include a product button PB for the user to access to the product related to the livestreamer. For example, the user may click the product button PB and access to other tabs with the ID of the livestreamer as a search keyword or the like.

In some embodiments, a “Go LIVE” button B may also be provided on the screen 600 for the user to go broadcasting via the terminal. In some embodiments, once the user clicks on the “Go LIVE” button B, a live streaming pre-setting page may be displayed on the region R for the user to do the pre-setting such as determining title, tags, event, virtual skin or the like. In some embodiments, the design and layout of the live streaming page may be determined flexibly according to the practical need. According to the embodiments, the user may have more options while operating the terminal or waiting for the product.

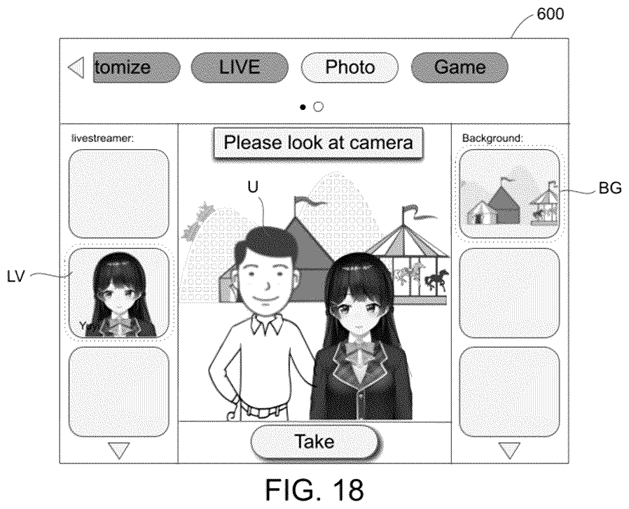

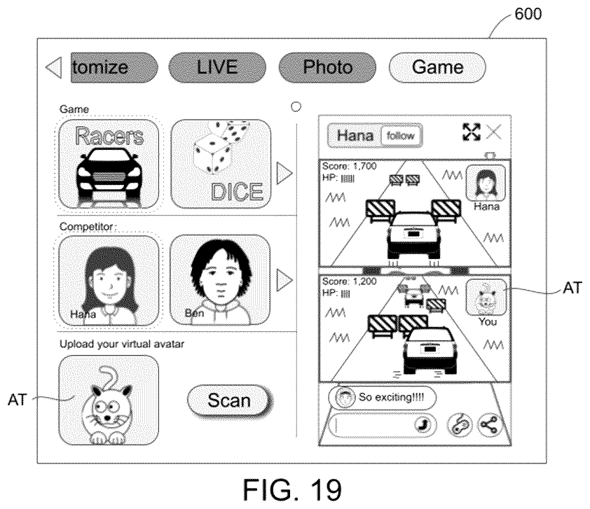

As shown in FIG. 18, the tab 602 of “photo” may be configured to be a photo booth. The user may take a selfie or take a picture with friends or the like. In some embodiments, the image or video of the user may also be used as context for manufacturing the customized product. For example, the user may select the product of a phone holder with a livestreamer and further add the selfie next to the livestreamer.

In some embodiments, there may be context such as the image of livestreamers LV or backgrounds BG as shown in FIG. 18 for the user U to select and have a photo with them. The image or video of the user U may be collected from the camera or the like. For example, the user U may select a virtual livestreamer LV and the background BG of the amusement park to take a photo of the livestreamer with the user being at the amusement park. In some embodiments, the tab 602 of “photo” may be a separated tab on the screen 600 or may be merged into the customized product list or the like. According to the embodiments, the users may use the default context and camera to customize their unique context.

In some embodiments, the chance of being a context in the photo booth may be a reward if the livestreamer or virtual liver wins an event in the live streaming platform. The fans of the livestreamer may support their favorite livestreamer to win the reward and then use the terminal to have a customized photo with their favorite livestreamer. Moreover, the live streaming platform may further organize campaigns or hold lotteries to motivate the viewer to, for example, share their customized photo or the like.

As shown in FIG. 19, the tab 602 of “Game” may be configured to be an arcade machine. In some embodiments, the game may be an offline or online game. A leaderboard (not shown) may be provided to rank the user according to the score in the game. The user may also select one or more than one competitor to play together. In some embodiments, the competitors may be a livestreamer or the other users in the live streaming platform. There may be a region R on the screen 600 to show the game screen of the user and the competitors or the like.

In some embodiments, the viewing unit 200 may receive information of a game selected by the user and receive information of another user selected by the user as an opponent. The viewing unit 200 may further generate a real-time battle UI according to the selected game and opponent. The viewing unit 200 may further render the real-time battle UI on the screen 600 for the user to play a game with another user. According to the embodiments, the user may have more options while operating the terminal or waiting for the product.

In some embodiments, the users may use a default avatar AT or upload their own avatar AT to play the game with the livestreamer in the live streaming room. For example, the camera may scan the user's appearance to generate an avatar for the user. The avatar may also be uploaded by scanning a QR code, image or the like. According to the embodiments, each user may have their own avatar and the user experience may be improved.

In some embodiments, a virtual avatar may also be purchased as a product by the user. For example, a QR code may be printed in the action figure the user purchased. The user may scan the QR by a terminal such as a smartphone or the like to obtain a virtual avatar. According to the embodiments, the user may have more options on purchasing products.

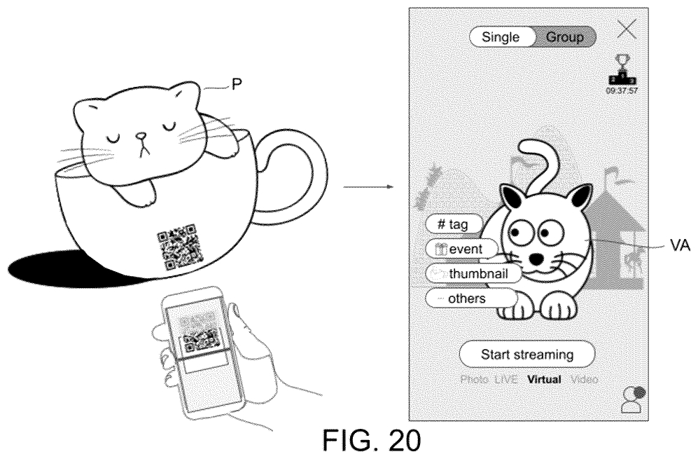

FIG. 20 is an illustrating example operation of the product P according to some embodiments of subject application. As shown in FIG. 20, the product P may include a code object such as the QR code. The user may scan the QR code on the product P and a virtual avatar VA may be imported into the user's smartphone or the like. In some embodiments, the virtual avatar VA may be generated by, for example, photo editing software, machine learning model, artificial intelligence program or the like.

In some embodiments, each product may include a unique virtual avatar. In other words, the points spent on the action figure may be equivalent to buying the perpetual usage rights for the virtual skin. In some embodiments, not only the virtual avatar, room background, special gift, chat frame, chat color in the live streaming room may also be obtained via the similar procedure. Furthermore, the user may access to the tab 602 of “LIVE” to make an attempt on go broadcasting by using the virtual avatar, background or the like. According to the embodiments, the user experience may be improved.

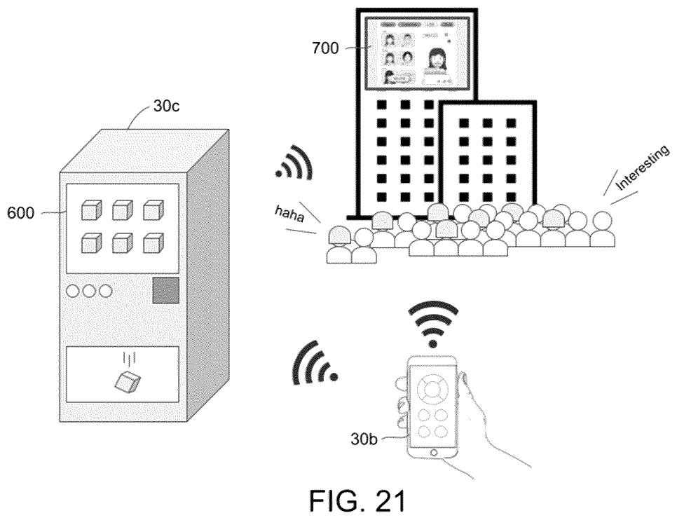

In some embodiments, the screen 600 of the terminal may also be projected to another big screen for display. FIG. 21 is an illustrating example operation of the terminal 30c according to some embodiments of subject application. As shown in FIG. 21, the screen 600 of the terminal 30c may be projected to another big screen 700 to showcase it to the public. In some embodiments, the big screen 700 may be the video wall on a building, a projection screen or the like. The purpose for projecting to a big screen may be for tutoring, promotion, advertisement, campaign, event or the like. In some embodiments, another terminal such as user terminal 30b may be used as a remote controller as shown in FIG. 21 for the user to demonstrate the operation of the terminal 30c remotely.

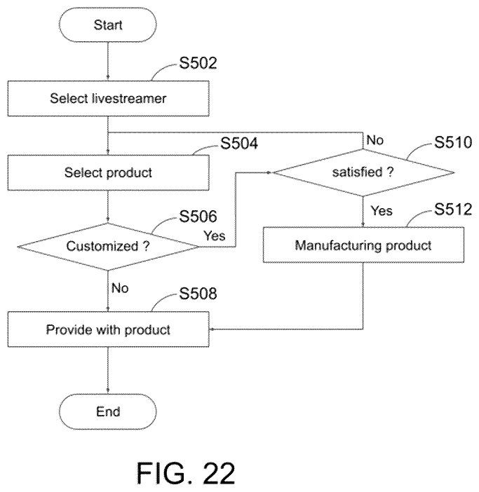

The operation of the live streaming system 1 with the above configuration will be now described. FIG. 22 is a flowchart showing steps of purchasing a product on a user terminal. Once a user logins in or enters as a guest to the user interface of the user terminal 30c, the user may browse the products by, for example, select the livestreamer (S502) and select the product (S504). In some embodiments, the user may also freely browse products and choose the items they desire based on their mood.

If the product the user selected is a pre-made product (No in S506), the terminal may provide the user with the product (S508) if the product is in stock and the user finishes the purchase. If the product the user selected is a customized product (Yes in S506), the terminal may determine whether the user satisfies a specific condition (S510). In some embodiments, the condition depends on the product the user selected. For example, if the customized product is only for a registered user with the status of VIP, the terminal may further check the identification of the user and its status or the like.

If the user does not satisfy the specific condition (No in S510), an error message may be displayed and the procedure may return to Step S504 for the user to re-select the product. If the user satisfies the specific condition (Yes in S510), the terminal 30c may proceed with manufacturing the customized product (S512). Furthermore, the terminal may provide the user with the product (S508) if the material is in stock and the user finishes the purchase.

In some embodiments, manufacturing of the customized products may be any possible method such as 3D printing, printing, die-casting, injection molding or the like. In some embodiments, hardware and software required for the mentioned manufacturing methods may be pre-installed on the terminal or connected to the terminal. In some embodiments, the products may be manufactured according to the customized product look-up table 274 or the like.

For example of 3D printing, the 3D models may be generated by various 3D modeling software, such as Blender, AutoCAD, SolidWorks or the like. In some embodiments, the file format for 3D printing may be STL (Standard Tessellation Language), OBJ (Wavefront OBJ), 3MF (3D Manufacturing Format) or the like. The file of the 3D model may be exported into suitable file formats and then inputted into a 3D printer for printing. In some embodiments, the file may be prepared in advance or uploaded by the user or the like.

According to the present disclosure, the product may be customized according to the user's preference and the user may also interact with the livestreamer in a more variety of ways. The user may further be a livestreamer to interact with the other livestreamer and purchase products in a more variety of ways. Therefore, the user experience may be improved.

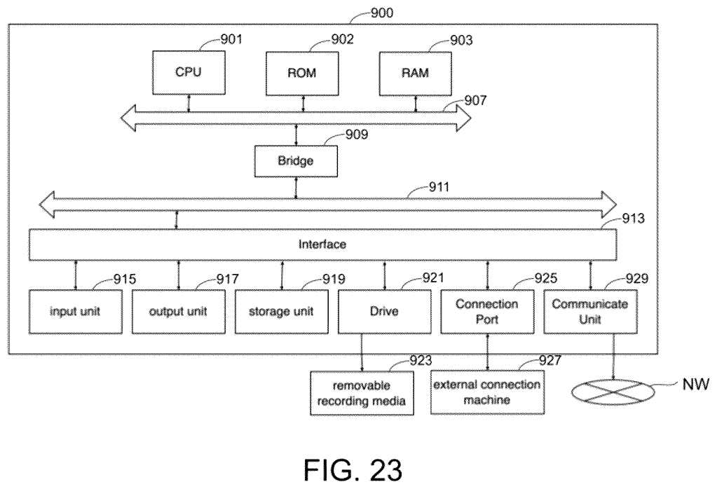

FIG. 23 is a schematic block diagram of computer hardware for carrying out a system configuration and processing according to some embodiments of subject application. The information processing device 900 in FIG. 23 is, for example, is configured to realize the server 10 and the user terminal 20, 30 respectively according to some embodiments of subject application.

The information processing device 900 includes a CPU 901, read only memory (ROM) 903, and random-access memory (RAM) 905. In addition, the information processing device 900 may include a host bus 907, a bridge 909, an external bus 911, an interface 913, an input unit 915, an output unit 917, a storage unit 919, a drive 921, a connection port 925, and a communication unit 929. The information processing device 900 may include imaging devices (not shown) such as cameras or the like. The CPU 901 is an example of hardware configuration to realize various functions performed by the components described herein. The functions described herein may be realized by circuitry programmed to realize such functions described herein. The circuitry programmed to realize such functions described herein includes a central processing unit (CPU), a digital signal processor (DSP), a general-use processor, a dedicated processor, an integrated circuit, application specific integrated circuits (ASICs) and/or combinations thereof. Various units described herein as being configured to realize specific functions, including but not limited to the streaming unit 100, the viewing unit 200, the video control unit 102, the audio control unit 104, the distribution unit 106, the UI control unit 108, the UI control unit 202, the rendering unit 204, the input transmit unit 206, the streaming info unit 302, the relay unit 304, the processing unit 306, the stream DB 320, the user DB 322, the purchase DB 324, the UI control unit 252, the inventory unit 254, the processing unit 256, the input transmit unit 258, the product DB 270, the material DB 272, the context DB 276, the game DB 278 and so on, may be embodied as circuitry programmed to realize such functions.

The CPU 901 functions as an arithmetic processing device and a control device, and controls the overall operation or a part of the operation of the information processing device 900 according to various programs recorded in the ROM 903, the RAM 905, the storage unit 919, or a removable recording medium 923. For example, the CPU 901 controls overall operations of respective function units included in the server 10 and the user terminal 20 and 30 of the above-described embodiment. The ROM 903 stores programs, operation parameters, and the like used by the CPU 901. The RAM 905 transiently stores programs used when the CPU 901 is executed, and parameters that change as appropriate when executing such programs. The CPU 901, the ROM 903, and the RAM 905 are connected with each other via the host bus 907 configured from an internal bus such as a CPU bus or the like. The host bus 907 is connected to the external bus 911 such as a Peripheral Component Interconnect/Interface (PCI) bus via the bridge 909.

The input unit 915 is a device operated by a user such as a mouse, a keyboard, a touchscreen, a button, a switch, and a lever. The input unit 915 may be a device that converts physical quantity to electrical signal such as audio sensor (such as microphone or the like), acceleration sensor, tilt sensor, infrared radiation sensor, depth sensor, temperature sensor, humidity sensor or the like. The input unit 915 may be a remote-control device that uses, for example, infrared radiation and another type of radio waves. Alternatively, the input unit 915 may be an external connection device 927 such as a mobile phone that corresponds to an operation of the information processing device 900. The input unit 915 includes an input control circuit that generates input signals on the basis of information which is input by a user to output the generated input signals to the CPU 901. The user inputs various types of data and indicates a processing operation to the information processing device 900 by operating the input unit 915.

The output unit 917 includes a device that can visually or audibly report acquired information to a user. The output unit 917 may be, for example, a display device such as an LCD, a PDP, and an OLED, an audio output device such as a speaker and a headphone, and a printer. The output unit 917 outputs a result obtained through a process performed by the information processing device 900, in the form of text or video such as an image, or sounds such as audio sounds.

The storage unit 919 is a device for data storage that is an example of a storage unit of the information processing device 900. The storage unit 919 includes, for example, a magnetic storage device such as a hard disk drive (HDD), a semiconductor storage device, an optical storage device, or a magneto-optical storage device. The storage unit 919 stores therein the programs and various data executed by the CPU 901, and various data acquired from an outside.

The drive 921 is a reader/writer for the removable recording medium 923 such as a magnetic disk, an optical disc, a magneto-optical disk, and a semiconductor memory, and built in or externally attached to the information processing device 900. The drive 921 reads out information recorded on the mounted removable recording medium 923, and outputs the information to the RAM 905. The drive 921 writes the record into the mounted removable recording medium 923.

The connection port 925 is a port used to directly connect devices to the information processing device 900. The connection port 925 may be a Universal Serial Bus (USB) port, an IEEE1394 port, or a Small Computer System Interface (SCSI) port, for example. The connection port 925 may also be an RS-232C port, an optical audio terminal, a High-Definition Multimedia Interface (HDMI (registered trademark)) port, and so on. The connection of the external connection device 927 to the connection port 925 makes it possible to exchange various kinds of data between the information processing device 900 and the external connection device 927.

The communication unit 929 is a communication interface including, for example, a communication device for connection to a communication network NW. The communication unit 929 may be, for example, a wired or wireless local area network (LAN), Bluetooth (registered trademark), or a communication card for a wireless USB (WUSB).

The communication unit 929 may also be, for example, a router for optical communication, a router for asymmetric digital subscriber line (ADSL), or a modem for various types of communication. For example, the communication unit 929 transmits and receives signals on the Internet or transmits signals to and receives signals from another communication device by using a predetermined protocol such as TCP/IP. The communication network NW to which the communication unit 929 connects is a network established through wired or wireless connection. The communication network NW is, for example, the Internet, a home LAN, infrared communication, radio wave communication, or satellite communication.

The imaging device (not shown) is a device that images real space using an imaging device such as a charge coupled device (CCD) or a complementary metal oxide semiconductor (CMOS), for example, and various members such as a lens for controlling image formation of a subject image on the imaging device and generates a captured image. The imaging device may capture a still picture or may capture a movie.

The present disclosure of the live streaming system 1 has been described with reference to embodiments. The above-described embodiments have been described merely for illustrative purposes. Rather, it can be readily conceived by those skilled in the art that various modifications may be made in making various combinations of the above-described components or processes of the embodiments, which are also encompassed in the technical scope of the present disclosure.

The procedures described herein, particularly flowchart or those described with a flowchart, are susceptible of omission of part of the steps constituting the procedure, adding steps not explicitly included in the steps constituting the procedure, and/or reordering the steps. The procedure subjected to such omission, addition, or reordering is also included in the scope of the present disclosure unless diverged from the purport of the present disclosure.

In some embodiments, at least a part of the functions performed by the server 10 may be performed by other than the server 10, for example, being performed by the user terminal 20 or 30. In some embodiments, at least a part of the functions performed by the user terminal 20 or 30 may be performed by other than the user terminal 20 or 30, for example, being performed by the server 10. In some embodiments, the rendering of the frame image may be performed by the user terminal of the viewer, the server, the user terminal of the livestreamer or the like.

Furthermore, the system and method described in the above embodiments may be provided with a computer-readable non-transitory storage device such as a solid-state memory device, an optical disk storage device, or a magnetic disk storage device, or a computer program product or the like. Alternatively, the programs may be downloaded from a server via the Internet.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed but includes another variation and modification that do not disobey the present disclosure, and is the scope covered by the following patent application scope.

DESCRIPTION OF REFERENCE NUMERALS

| | | | |
|---|---|---|---|
| 1 | Live streaming system | 10 | Server |
| 20 | User terminal | 100 | Streaming unit |
| 102 | Video control unit | 104 | Audio control unit |
| 106 | Distribution unit | 108 | UI control unit |
| 200 | Viewing unit | 202 | UI control unit |
| 204 | Rendering unit | 206 | Input unit |
| 250 | manufacturing unit | 252 | UI control unit |
| 254 | inventory unit | 256 | processing unit |
| 270 | product DB | 272 | material DB |
| 274 | customized product look-up | 276 | context DB |
| | table | | |
| 278 | game DB | 30, 30a, 30b | User terminal |
| 302 | Streaming info unit | 304 | Relay unit |
| 306 | processing unit | 320 | Stream DB |
| 322 | User DB | 600 | Screen |
| 602 | tab | 700 | Screen |
| 900 | Information processing device | 901 | CPU |
| 903 | ROM | 905 | RAM |
| 907 | Host bus | 909 | Bridge |
| 911 | External bus | 913 | Interface |
| 915 | Input unit | 917 | Output unit |
| 919 | Storage unit | 921 | Drive |
| 923 | Removable recording medium | 925 | Connection port |
| 927 | External connection device | 929 | Communication unit |
| LS | Live streaming | LV | livestreamer |
| NW | Network | SP | Specific portion |

| | |
|---|---|
| AU1, AU2 | Viewer |
| SS02, S504, S506, S508, S510, S512 | Step |
| VD, VD1, VD2 | Video |

What is claimed is:

1. A terminal comprising a circuitry, wherein the circuitry is configured to perform:
generating a first streaming data of a first user;
transmitting the first streaming data to a server;
receiving a second streaming data from the server;
reproducing the second streaming data on a screen of the terminal;
receiving information of a product selected by the first user;
providing the selected product to the first user.

2. The device according to claim 1, further comprising:
determining whether the selected product being a pre-made product or a customized product; and
manufacturing the selected product in response to the selected product being the customized product; wherein
manufacturing the selected product is realized by one or more of the following methods: 3D printing, printing, die-casting or injection molding.

3. The terminal according to claim 1, wherein:
the second streaming data include live streaming data or archived streaming data of a second user; and
the selected product includes information related to the second streaming data.

4. The terminal according to claim 3, further comprising:
transmitting a reward to the second user in response to the second user being on broadcasting when the selected product being purchased; and
providing an archive video of a clip of the second user receiving the reward.

5. The terminal according to claim 1, further comprising:
collecting video data of the first user;
rendering the second streaming data on the video data; and
generating an image of the second streaming data on the video data in response to an operation from the first user.

6. The terminal according to claim 1, wherein:
the selected product includes a code to convert into a virtual skin via a second terminal;
the virtual skin is used for virtual avatar or virtual background during broadcasting.

7. The terminal according to claim 1, further comprising:
receiving information of a game selected by the first user;
receiving information of a second user selected by the first user;
generating a real-time battle UI according to the selected game and second user;
rendering the real-time battle UI on the first streaming data.

8. The terminal according to claim 1, further comprising:
projecting content displayed on the screen onto a second screen;
controlling the content displayed on the screen via a second terminal.

9. A method for operating functions of a vending machine, comprising:
generating a first streaming data of a first user;
transmitting the first streaming data to a server;
receiving a second streaming data from the server;
reproducing the second streaming data on a screen of the terminal;
receiving information of a product selected by the first user;
providing the selected product to the first user.

10. A non-transitory computer-readable medium including program instructions, that when executed by one or more processors, cause the one or more processors to execute:
generating a first streaming data of a first user;
transmitting the first streaming data to a server;
receiving a second streaming data from the server;
reproducing the second streaming data on a screen of the terminal;
receiving information of a product selected by the first user;
providing the selected product to the first user.
